(19) United States
(12) Patent Application Publication
(10) Pub. No.: US 2014/0300080 A1
(43) Pub. Date: Oct. 9, 2014

(54) The heel buddy

(71) Applicant: Jae Hyun, Porter Ranch, CA (US)

(72) Inventor: Jae Hyun, Porter Ranch, CA (US)

(21) Appl. No.: 13/986,155

(22) Filed: Apr. 8, 2013

(51) Int. Cl. B62J 13/00

(52) U.S. Cl. CPC B62J 13/00
USPC 280/304.3

(57) ABSTRACT

The Heel Buddy Heel Buddy is a motorcycle accessory that allows the rider to rest their heel on the peg and the rest when coming into a sharp corner in a racing situation and in a racing position. It allows the foot and knee to be placed in the proper position for greater performance and for added safety as well as stability.

### BACKGROUND OF THE INVENTION

(1) Field of the Invention

The Heel Buddy lies within the field of motorcycle racing accessories.

(2) Description of the art including information disclosed under 37 CFR 1.97 & 1.98

The art described in the drawings of the design are as shown.

### BRIEF SUMMARY OF THE INVENTION

The Heel Buddy is a new design to allow a motorcycle rider to place their heel in a 30 Degree to a 55 Degree angle while racing into corners.

### BRIEF DESCRIPTION OF THE SEVERAL VIEWS OF THE DRAWINGS

There are 8 drawings in total that describe and illustrate the design and function of the Heel Buddy.

FIG. 1: is the left side view of the motorcycle showing the Heel Buddy in place.

FIG. 2: is the left side front view of the Heel Buddy.

FIG. 3: is the front left angle view of the Heel Buddy.

FIG. 4: is the left side top view and angle of the Heel Buddy.

FIG. 5: is the right side view of the motorcycle showing the Heel Buddy in place.

FIG. 6: is the front right side view of the Heel Buddy.

FIG. 7: is the front right side angle view of the Heel Buddy.

FIG. 8: is the right side top view and angle of the Heel Buddy.

### DETAILED DESCRIPTION OF THE PREFFERED EMBODIMENT

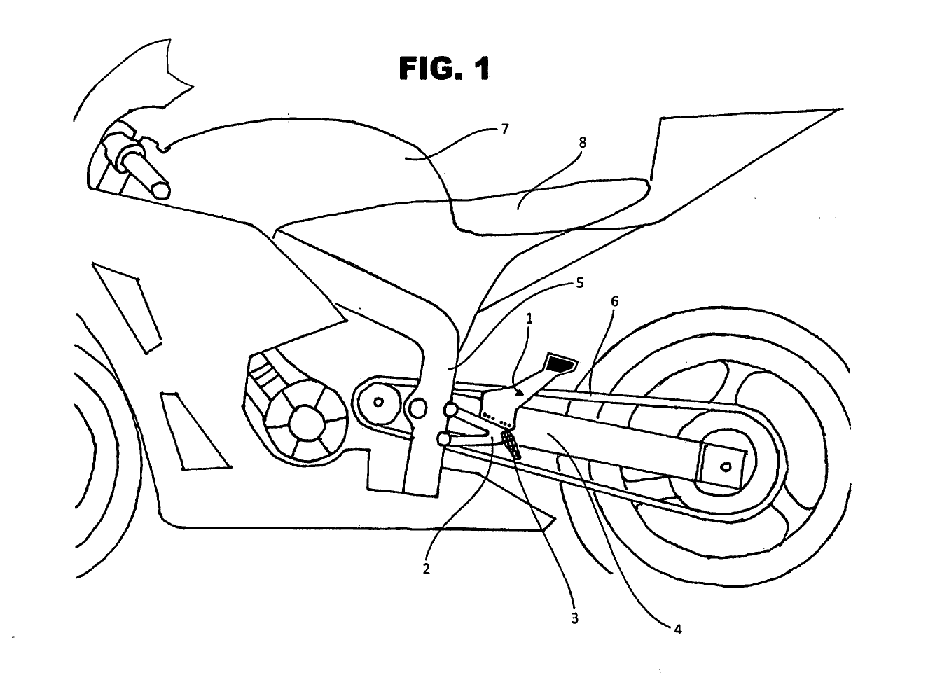

FIG. 1: Illustrates the left side of the motorcycle with #1 the left side Heel Buddy with #2 the foot peg assembly attached by two bolts with #3 the motorcycle foot peg attached to the foot peg assembly with #4 the swing arm of the motorcycle with #5 the motorcycle frame which holds the foot peg assembly in place by the two bolts with #6 the motorcycle chain which is shielded from the heel by the Heel Buddy attachment with #7 the motorcycle gas tank with #8 the motorcycle seat for a full perspective of the Heel Buddy in composition to the motorcycle as a whole.

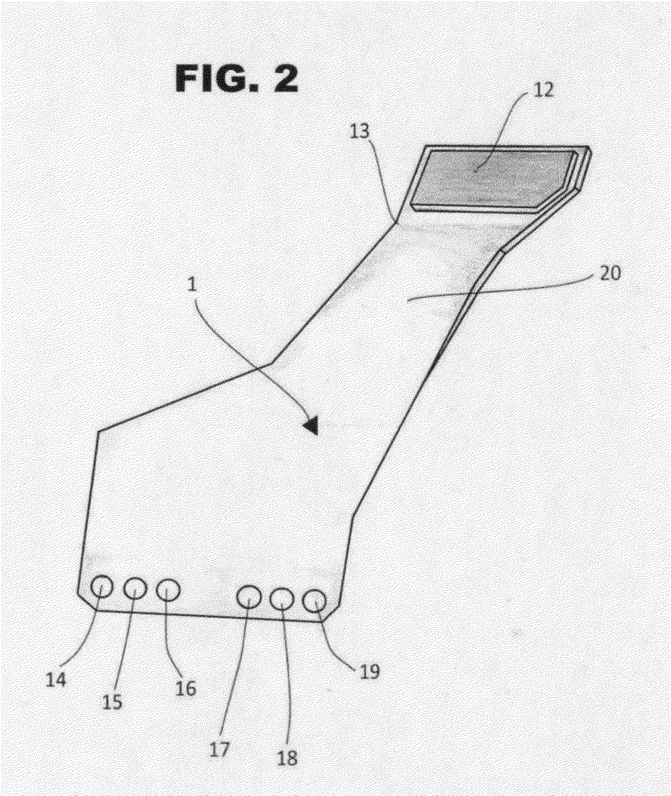

FIG. 2: Illustrates the #1 Heel Buddy at a front view with #12 the left side set rubber mold attached to the top portion of the left side of the Heel Buddy to provide traction with #13 the 30 to 55 Degree angle bend for the rider's heel to be placed flat onto the rubber mold when in cornering (pivot) position with #14 and #17 holes for the foot peg assembly bolts are paired with #15 and #18 holes are paired and #16 and #19 holes are paired for the adjustability of the placement of the Heel Buddy as different riders have different boot sizes with #20 the neck or extension of the Heel Buddy.

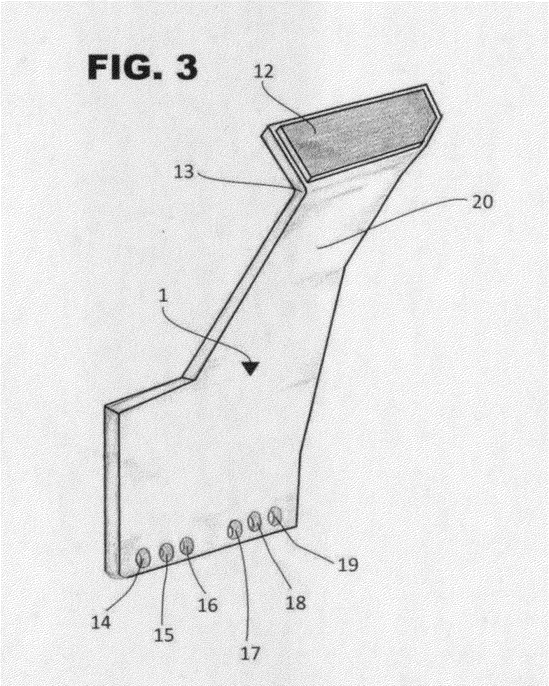

FIG. 3: Illustrates the #1 Heel Buddy at a front left angle view with #12 the left side set rubber mold attached to the top portion of the left side of the Heel Buddy to provide traction with #13 the 30 to 55 Degree with Heel Buddy angle bend for the riders heel to be placed flat onto the rubber mold when in cornering (pivot) position with #14 and #17 holes for the foot peg assembly bolts are paired with #15 and #18 holes are paired and #16 and #19 holes are paired for the adjustability of the placement of the Heel Buddy as different riders have different boot sizes with #20 the neck or extension of the Heel Buddy.

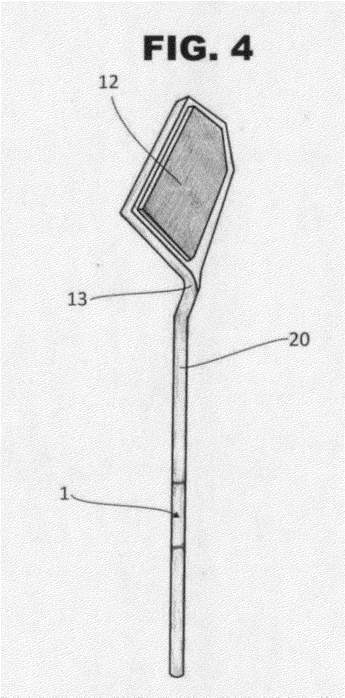

FIG. 4: Illustrates the left angle extreme top view of the Heel Buddy with the angle of 30 to 55 Degree with #1 the Heel Buddy with #12 the rubber mold as described in FIGS. 2 and 3 with #13 the 30 to 55 Degree angle of the Heel Buddy with #20 the neck or extension portion of the Heel Buddy.

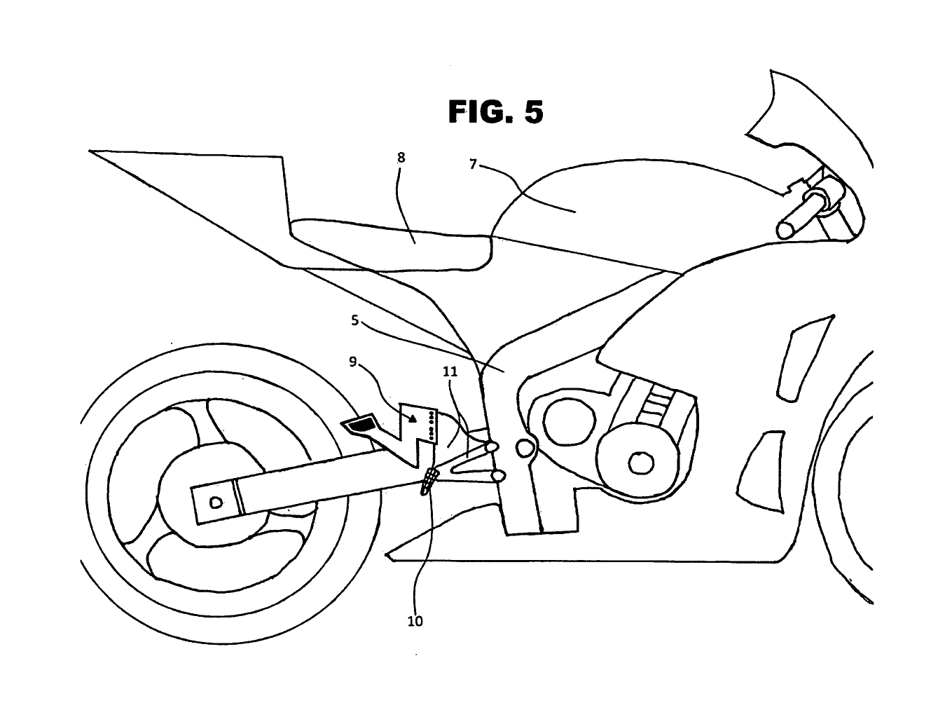

FIG. 5: Illustrates the right side of the motorcycle with #5 the frame that the #11 the foot peg assembly attaches to with #9 the Heel Buddy with #10 the foot peg attached to the foot peg assembly with #7 the gas tank and #8 the motorcycle seat to give a better perspective for the Heel Buddy.

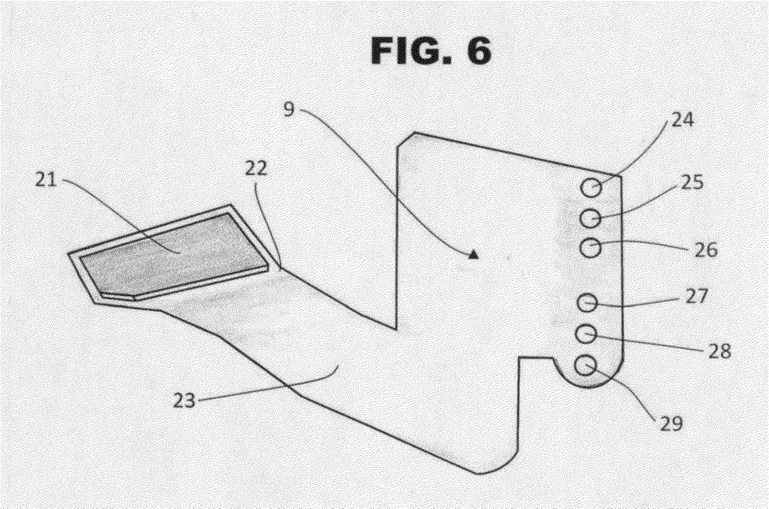

FIG. 6: Illustrates the right side front view of the Heel Buddy with #9 the body of the Heel Buddy with #21 the rubber mold portion with #22 the 30 to 55 Degree angle with #23 the neck or extension of the Heel Buddy with #24 and #27 holes paired with #25 and #28 holes paired with #26 and #29 holes are paired for the adjustability of the Heel Buddy to fit different boot sizes.

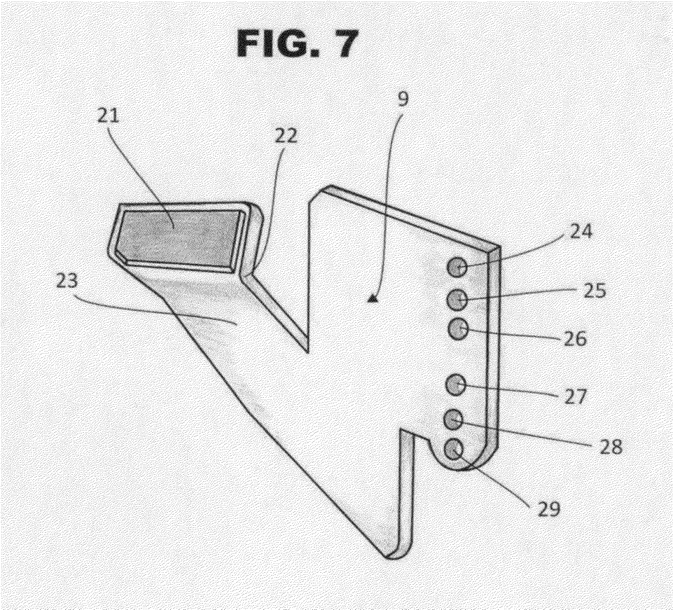

FIG. 7: Illustrates the right side angle view of the Heel Buddy with #9 the body of the Heel Buddy with #21 the rubber mold portion with #22 the 30 to 55 Degree angle with #23 the neck or extension of the Heel Buddy with #24 and #27 holes paired with #25 and #28 holes paired with #26 and #29 holes are paired for the adjustability of the Heel Buddy to fit different boot sizes.

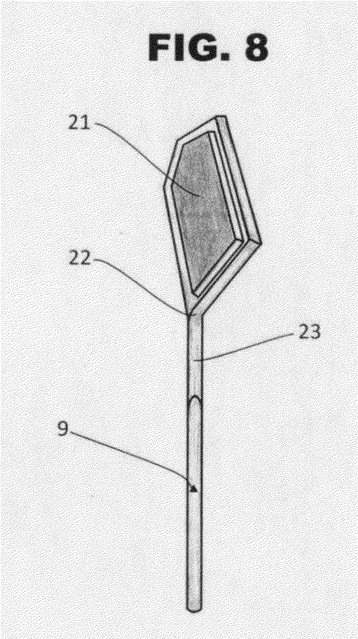

FIG. 8: Illustrates the extreme right side view of the Heel Buddy with #9 the body of the Heel Buddy with #21 the rubber mold insert with #22 the 30 to 55 Degree angle with #23 neck or extension of the Heel Buddy.

### DETAILED DESCRIPTION OF THE INVENTION

The left-hand set of the invention (Heel Buddy) functions as a set with the right-hand set. Also functions as a shield to prevent motorcycle chain from hitting the left heel of motorcycle rider. Made from a cutout of an aluminum plate. The Heel Buddy has a 30 to 55° degree bend in order for motorcycle rider's heel to be placed flat onto the rubber mold when in cornering (pivot) position as the rider approaches a high-speed corner, the position of the rider's foot should be pivoted in the direction of the corner in order to turn effectively. When the rider's foot is pivoted on the foot peg, the direction of the knee should naturally align with the direction of the foot, and the direction of the corner. This naturally causes the rider's knees to stick out during cornering as done by every professional motorcycle racer. While in the pivot position, all of the rider's weight is transferred to the ball of the feet, which causes tremendous stress to the calves and the quadriceps as there is nothing supporting the heel of the rider. This is where the Heel Buddy is used to help distribute the weight throughout the entire foot by allowing the rider to place the heel on the rubber mold of the Heel Buddy. This distribution of weight helps relieve the strain on the rider's legs and offer more stability which leads to a more effective high-speed cornering.

(Left-hand Set) Hole drilled for a bolt to attach the Heel Buddy to the foot peg assembly. The Heel Buddy is attached to the foot peg assembly using two bolts. Multiple drill holes are for the adjustability of the placement of the Heel Buddy as different motorcycle riders have different boot sizes.

(Left-hand Set) The extension (neck) with a 30 to 55 Degree bend of the Heel Buddy. Purposely designed in a manner so the boot of the motorcycle rider will not catch any edges (the inside heel of the boot will simply slide up and down on the neck of the Heel Buddy when moving in and out of the pivot position) and not cause any interference while riding.

(Right-hand Set) Rubber mold attached to the top part of the left-side set of Heel Buddy to provide traction.

(Right-hand Set) 30 to 55 Degree bend in order for motorcycle rider's heel to be placed flat onto the rubber mold when in pivot position.

(Right-hand Set) The extension (neck) of the Heel Buddy. Purposely designed in a manner so the boot of the motorcycle rider will not catch any edges (the inside heel of the boot will simply slide up and down on the neck of the Heel Buddy when moving in and out of the pivot position) and not cause any interference while riding.

(Right-hand Set) Hole drilled for a bolt to attach the Heel Buddy to the rear-set. The Heel Buddy is attached to the foot peg assembly using two bolts. Multiple drill holes are for the adjustability of the placement of the Heel Buddy as different motorcycle riders have different boot sizes.

What is claimed is:

1: The Heel Buddy invention is made of a metal such as aluminum, steel, or carbon fiber composite and is attached to the side of the motorcycle and is made in such a design that it fits many different motorcycles for such functions as:
(A) It acts as a shield to prevent the chain from hitting the rider's foot.
(B) It provides greater performance and safety.

2: The Heel Buddy invention is a molded carbon fiber composite or a machine cut piece from a metal that is angled towards the top at a 30 to 55 Degree angle named the pivot position with a rubber mold piece for the heel to rest upon and to position the knee for fast speeds and sharp cornering in a racing environment.

3: The Heel Buddy invention is purposely designed in a manner with hole and bolt settings that allow for different boot sizes so the boot of the rider will not catch any edges because the inside heel of the boot will slide up and down on the neck of the Heel Buddy when moving in and out of the pivot position and not cause any interference while riding the motorcycle.
